(19) United States
(12) Patent Application Publication
(10) Pub. No.: US 2008/0056249 A1
(43) Pub. Date: Mar. 6, 2008

(54) EXTRACTING SHARED STATE INFORMATION FROM MESSAGE TRAFFIC

(75) Inventors: Matt Ocko, Palo Alto, CA (US); George Tuma, Scotts Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Teneros, Inc., Mountain View, CA (US)

(21) Appl. No.: 11/756,538

(22) Filed: May 31, 2007

Related U.S. Application Data
(60) Provisional application No. 60/810,073, filed on May 31, 2006.

(51) Int. Cl. H04L 12/56

(52) U.S. Cl. 370/389

(57) ABSTRACT

An approach to having a shared state from one system to another is to represent data in one system according to service traffic of the other system. For example, by intercepting service traffic associated with a first entity, identifying a data object representing at least a portion of the state of the first entity in the service traffic, and updating a corresponding portion of a shared state data structure in accordance with a value of the data object, the shared state can be maintained outside of the first entity. This process can be extended to maintaining shared state of more than one entity. The service traffic might be e-mail service traffic, database service traffic, or the like. Synchronization commands can be used to initiate at least a portion of the service traffic. The shared state can be used for backups, record-keeping, service migration, disaster recovery, fail-over and/or fault tolerance improvements. In some instances, an application fingerprint can be applied to the service traffic to identify a context of the first data object, with such objects being caching based on context.

### CROSS-REFERENCE TO RELATED APPLICATIONS

This application claims priority from co-pending U.S. Provisional Patent Application No. 60/810,073 filed May 31, 2006 entitled “Extracting Shared State Information From Message Traffic” which is hereby incorporated by reference, as if set forth in full in this document, for all purposes.

The present disclosure may be related to the following commonly assigned applications/patents:

U.S. patent application Ser. No. 11/166,043, filed Jun. 24, 2005 and entitled “Autonomous Service Backup and Migration” (now U.S. Patent Publication No. 2006/0015641, published Jan. 19, 2006) to Ocko et al. (hereinafter “Ocko I”);

U.S. patent application Ser. No. 11/166,359, filed Jun. 24, 2005 and entitled “Network Traffic Routing” (now U.S. Patent Publication No. 2006/0015645, published Jan. 19, 2006) to Ocko et al. (hereinafter “Ocko II”);

U.S. patent application Ser. No. 11/165,837, filed Jun. 24, 2005 and entitled “Autonomous Service Appliance” (now U.S. Patent Publication No. 2006/0015584, published Jan. 19, 2006) to Ocko et al. (hereinafter “Ocko III”); and

U.S. patent application Ser. No. 11/166,334, filed Jun. 24, 2005 and entitled “Transparent Service Provider” (now U.S. Patent Publication No. 2006/0015764, published Jan. 19, 2006) to Ocko et al. (hereinafter “Ocko IV”).

The respective disclosures of these applications/patents are incorporated herein by reference in their entirety for all purposes.

### FIELD OF THE INVENTION

The present invention relates to software application and data management in general and in particular to software applications whose state is extracted from message traffic.

### BACKGROUND OF THE INVENTION

Organizations and business enterprises typically have one or more core service applications that are vital to their operations. For example, many organizations rely on e-mail, contact management, calendaring, and electronic collaboration services provided by one or more service applications. In another example, a database and associated applications can provide the core operations used by the organization. These core services are critical to the normal operation of the organization. During periods of service interruption, referred to as service downtime, organizations may be forced to stop or substantially curtail their activities. Thus, service downtime can substantially increase an organization's costs and reduce its efficiency.

A number of different sources can cause service downtime. Critical services may be dependent on other critical or non-critical services to function. A failure in another service can cause the critical service application to fail. For example, e-mail service applications are often dependent on directory services, such as Active Directory, one configuration of which is called Global Catalog, to function. Additionally, service enhancement applications, such as spam message filters and anti-virus applications, can malfunction and disable a critical service application.

Additionally, catastrophic failures and disasters can lead to extended periods of downtime. If an organization's data center is destroyed or otherwise disabled, it may be faster for the organization to rebuild a new data center to restore critical services, rather than repair the damaged data center. To prepare for catastrophic failures and disasters, organizations often maintain redundant data centers in different locations, each of which is capable of providing critical services. Additionally, organizations often perform frequent data backups to preserve critical data.

Maintaining redundant data centers is complicated to configure, expensive to maintain, and often fails to prevent some types of service downtime. For example, if a defective software update is installed on one service application in a clustered system, the defect will be mirrored on all of the other service applications in the clustered system. As a result, all of the service applications in the system will fail and the service will be interrupted. Additionally, it is difficult to ensure data synchronization among multiple redundant data centers.

Data backups are also fraught with problems. Data backups often based on storing a data block level copy of the data. If the database, data structures, or file system is corrupt, the backup also becomes corrupted, making the backup worthless. Moreover, backup data must typically be restored in bulk. It is difficult and time consuming to restore an arbitrary portion of the data, such as a single file or e-mail message.

Journaling systems maintain logs that record data transactions. This allows for the reconstruction of data from its initial state to any subsequent state. However, journaling systems require the storage of a known and valid (i.e. not corrupt) initial state. Otherwise, it is impossible to reconstruct any data. Additionally, journaling requires large amounts of data storage to store both the initial state of a system and logs of all subsequent transactions.

Moreover, journaling systems are difficult to use for disaster recovery. The target system where the data is to be restored must have the same initial state as the source system where the data was backed up. As the target system in disaster recovery situations is often a completely different system than the source system (because the source system is destroyed or unavailable), this present substantial difficulties. Moreover, even if the target system can be set to an identical initial state as the source system, the target system and its services must remain offline and isolated from users while the journalled data is being reconstructed. Otherwise, ongoing user actions could interfere with and inadvertently corrupt data on the target system. Additionally, journalled data requires substantial bandwidth to communicate logs of transactions during data reconstruction.

It is therefore desirable for an improved disaster recovery system and method that is resistant to data and file corruption and allows for reconstruction of arbitrary quantities of data. It is further desirable for a system and method to facilitate migration to different target systems without requiring synchronization to a known initial state. It is also desirable for the system and method to allow target systems to synchronize with backup data while providing services to users. It is also desirable for a system and method to efficiently represent, compress, and/or communicate service data for disaster recovery, system migration, data synchronization, and other applications.

### BRIEF SUMMARY OF THE INVENTION

An approach to having a shared state from one system to another is to represent data in one system according to service traffic of the other system. For example, by intercepting service traffic associated with a first entity, identifying a data object representing at least a portion of the state of the first entity in the service traffic, and updating a corresponding portion of a shared state data structure in accordance with a value of the data object, the shared state can be maintained outside of the first entity. This process can be extended to maintaining shared state of more than one entity. The service traffic might be e-mail service traffic, database service traffic, or the like. Synchronization commands can be used to initiate at least a portion of the service traffic. The shared state can be used for backups, record-keeping, service migration, disaster recovery, fail-over and/or fault tolerance improvements. In some instances, an application fingerprint can be applied to the service traffic to identify a context of the first data object, with such objects being caching based on context.

The following detailed description together with the accompanying drawings will provide a better understanding of the nature and advantages of the present invention.

### BRIEF DESCRIPTION OF THE DRAWINGS

The invention will be described with reference to the drawings, in which:

FIG. 1 is a block diagram illustrating a system including a service appliance for improving service reliability and a disaster recovery appliance according to an embodiment of the invention.

FIG. 2 illustrates an example of shared state information.

FIG. 3 illustrates a method of creating shared state information.

FIG. 4 illustrates an example of restoring service information on a target system.

FIG. 5 illustrates a method of determining an efficient representation of service data for storage, compression, and communication.

### DETAILED DESCRIPTION OF THE INVENTION

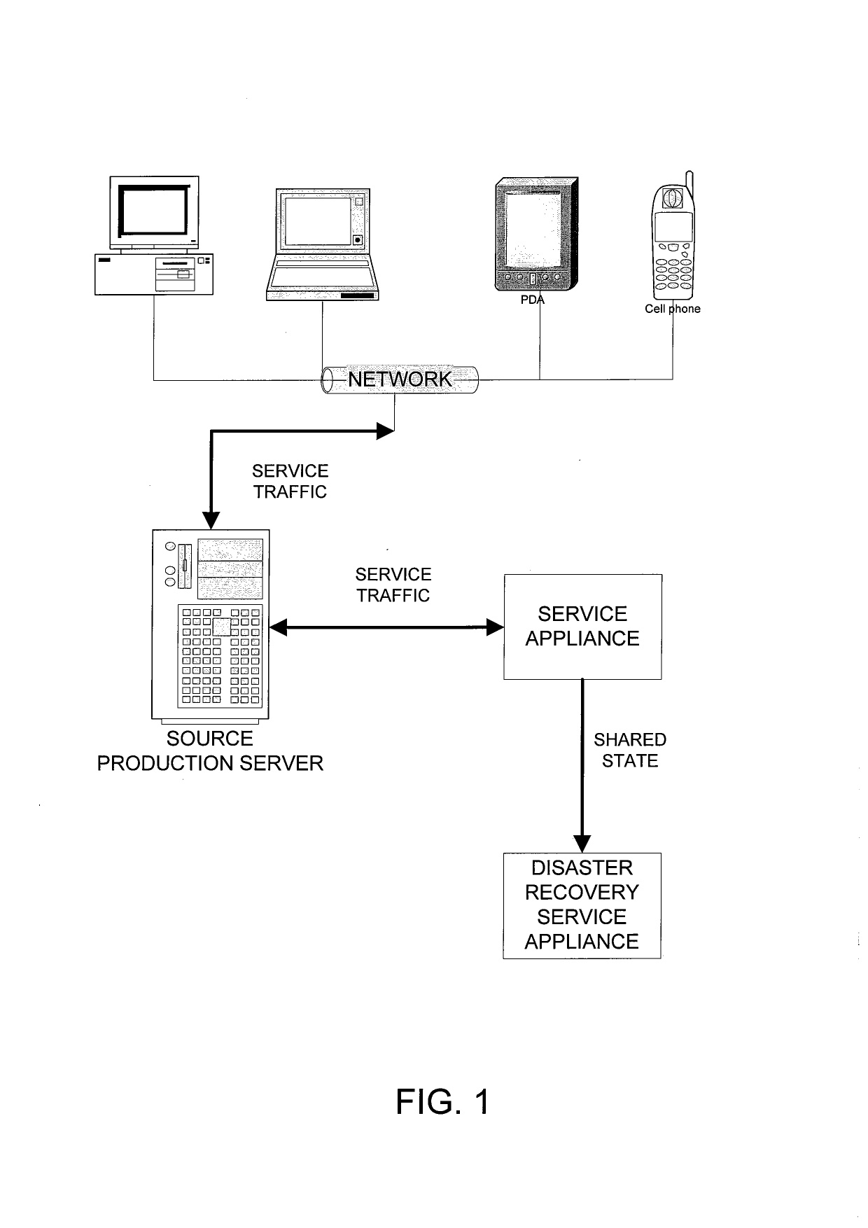

FIG. 1 illustrates an example system including a service appliance for improving service reliability and a disaster recovery appliance according to an embodiment of the invention. In this example, a production server includes one or more service applications that provide one or more services to client systems. The production server may be operated by a single computer system or multiple computer systems operating in parallel. The production server exchanges service traffic with client systems. Service traffic typically includes commands, data, and command responses exchanged between the production server and clients in the course of providing one or more services. An example of service traffic for an e-mail service can include a message request command from a client requesting any new e-mail messages and a message request response from the production server including data corresponding one or more new e-mail messages. Other examples of service applications include but are not limited to web servers and database applications. The production server can also issue commands to one or more clients, with clients providing command responses and optionally data to the production server.

In an embodiment, a service appliance intercepts service traffic between the production server and clients. A service appliance may be connected inline between one or more production servers and clients. Additionally, the network may be configured to route service traffic or a copy of the service traffic to the service appliance regardless of its location on the network.

In a further embodiment, the service appliance and production server generate additional service traffic directly. For example, the service appliance can send commands to the production server, which then provides command responses and data back to the service appliance. The service appliance and production server may communicate using the same protocols and APIs as those used by clients and/or different protocols and APIs, such as a specialized synchronization protocol and API.

Regardless of the source of the service traffic, an embodiment of the service appliance analyzes the service traffic to create shared state data. Shared state data represents the complete state of the service data resulting from the exchanges of service traffic. Unlike a log file, the shared state does not include a record of the service traffic itself, rather, the shared state represents only the results of the service traffic.

As discussed in detail below, the shared state data can be stored, for example using serialization techniques, and exported to a disaster recovery appliance. After a disaster or catastrophic failure of a production server, the shared state data can be loaded back into a new target production server, thereby restoring the service and its service data.

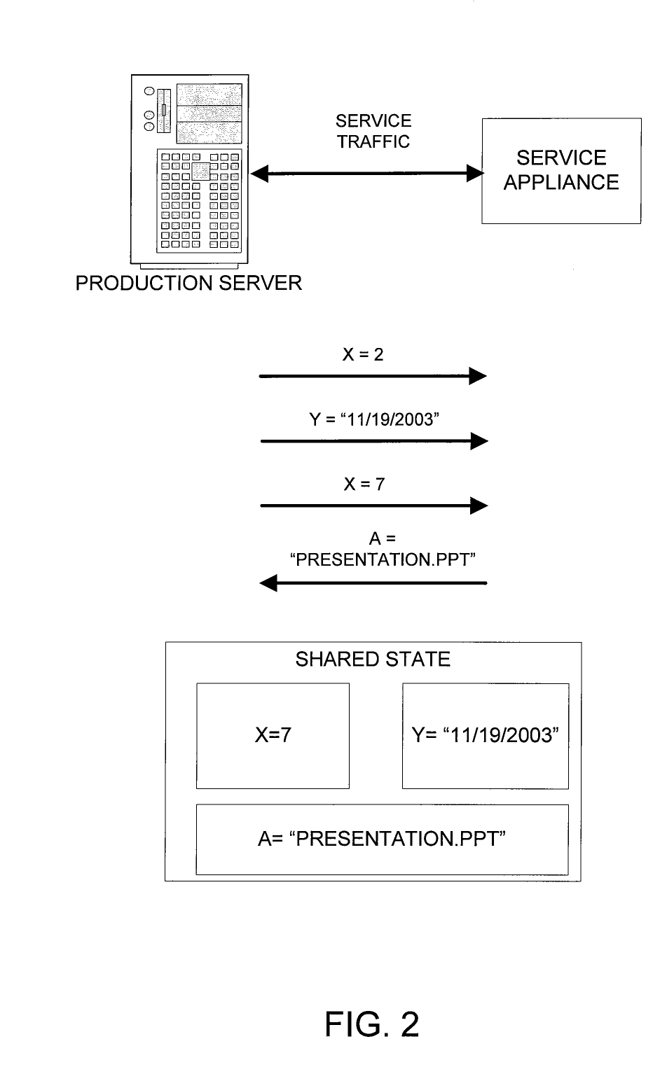

FIG. 2 illustrates an example of shared state information according to an embodiment of the invention. In this example, service traffic is exchanged between a service appliance and the production server. A first example service traffic message from the production server to the service appliance sets a variable X equal to 2. A second example service traffic message from the service appliance to the production server sets a variable Y equal to the date Nov. 19, 2003. It should be noted that service traffic can include data of any arbitrary static or dynamic data type and structure, including compound data structures and data objects. A third example service traffic message from the production server to the service appliance sets a variable X equal to 7. A fourth example service traffic message from the service appliance to the production server sets a data object A equal to a presentation data file “Presentation.ppt.” In this example, the fourth example service traffic message may include the data file. For example, service traffic communicating an e-mail message may also include a data file of an attachment to the e-mail message.

The service appliance analyzes service traffic coming from and going to the production server to construct shared state data. In an embodiment, the shared state data represents the set of data objects affected by the service traffic. In this example, the shared state data includes data objects representing variable X, which equals 7; variable Y, which equals the date Nov. 19, 2003; and data object A, equal to the presentation data file “Presentation.ppt.” It should be noted that the shared state data includes the most recent value of service data. As service traffic updates or modifies the service data, the shared state data is updated accordingly.

Moreover, the shared state data represents the union of service data of the service appliance, the production server, and any other entities under consideration. Unlike common data synchronization schemes, where a target system attempts to replicate the data of a source system, the shared state data represents the collective state of all of the entities under consideration.

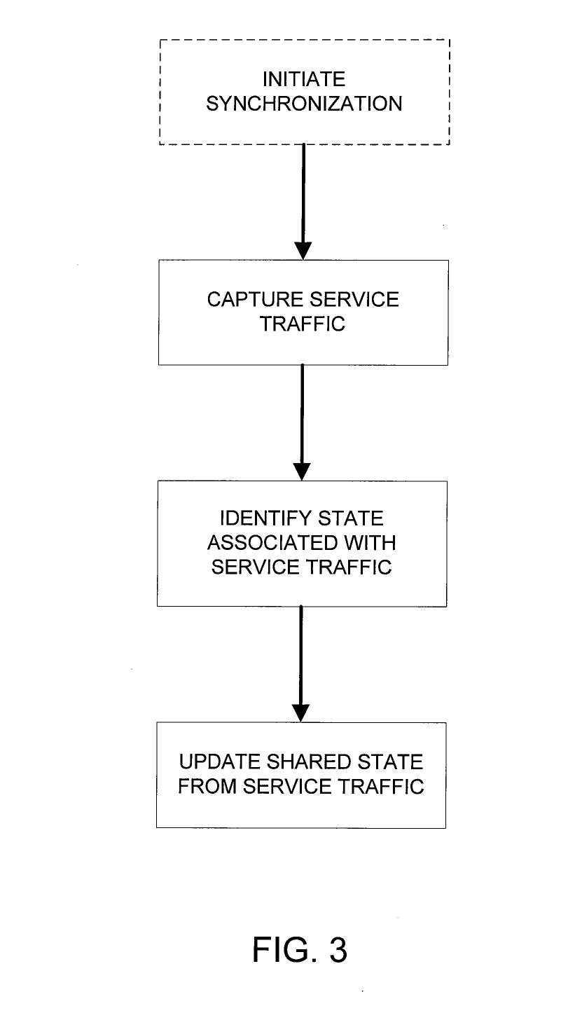

FIG. 3 illustrates a method of creating shared state information according to an embodiment of the invention. An optional initial step initiates a synchronization operation from one or more production servers. This optional step ensures that the service traffic includes information on all of the data maintained by production servers. This step may be omitted if the normal service traffic from production servers pertains to all of the production servers' data, or if the service appliance is only interested in data included in normal service traffic.

Service traffic is then captured by the service appliance. As discussed above, the service appliance captures service traffic coming from and going to production servers. The captured service data is analyzed to determine the data objects associated with the service traffic. The shared state data is then updated accordingly. In an embodiment, the shared state data is updated by executing the commands included in service traffic on the appropriate data objects in the shared state data. This can be done using a version of the service application employed by production servers or using a compatible or equivalent application. In another embodiment, the service appliance updates the shared state data by emulating the functionality of the service application.

After the shared state data is created, an embodiment of the service appliance stores the shared state data for future use. In a further embodiment, the shared state data may be serialized or converted to any type of file format. In still a further embodiment, the shared state data may be exported to a disaster recovery appliance or a local or remote storage device.

In an embodiment using a Microsoft Exchange™ service application, a COM server component is registered at the source location and a similar component is registered at the target location. For practical purposes, these two COM components may be rolled into the same DLL. The export component on the source location (named “SyncOnSrc”, for example) captures all the changes and transforms them into a series of manageable chunks of data and persists them on the file system. The import component on the target location can be named “SyncOnDest”, for example.

On the source side, the method IExchangeExportChanges is called to obtain all the changes and synchronization is attempted. However, calls to the method IExchangeImportContentsChanges are intercepted and the change parameters are stored in memory streams. Later, these streams are stored on the file system and state is saved. Similarly, on the target side, synchronization is effected by going through all items in the data stream (that is sent across from the source). The methods of IExchangeImportContentsChanges are called to apply the change to the database.

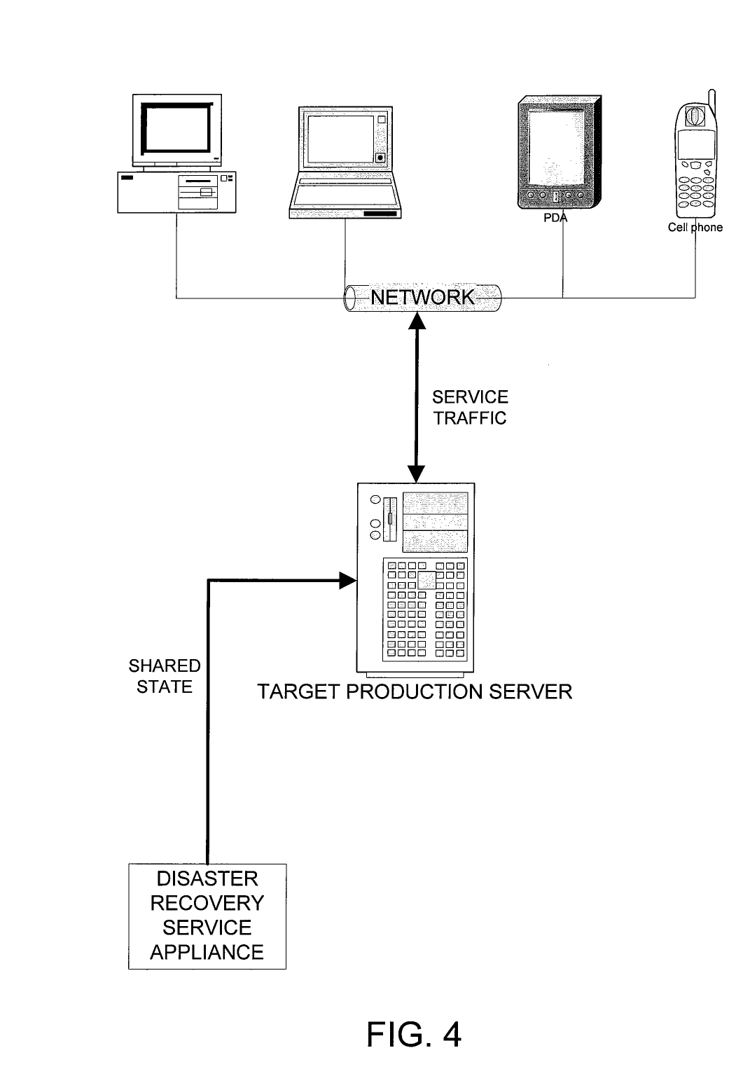

FIG. 4 illustrates an example of restoring service information on a target system according to an embodiment of the invention. Following a disaster, catastrophic failure, or migration of the production server, a disaster recovery appliance or a local or remote storage device may be used to restore service data on a target production server that replaces the source production server. Embodiments of the disaster recovery appliance can restore service data using the same protocols and APIs as those used by clients and/or different protocols and APIs, such as a specialized synchronization protocol and API.

In further embodiments, because the service data is restored using the native protocols of the service application on the target production server, this restoration can be performed in the background while the target production server continues to provide services to clients. Moreover, because the shared state data represents service data in its application-specific form (e.g., date information is stored as a date data object), it is possible to restore any arbitrary portion of the service data, such as individual e-mail messages, user accounts, or data files only associated with particular users or projects.

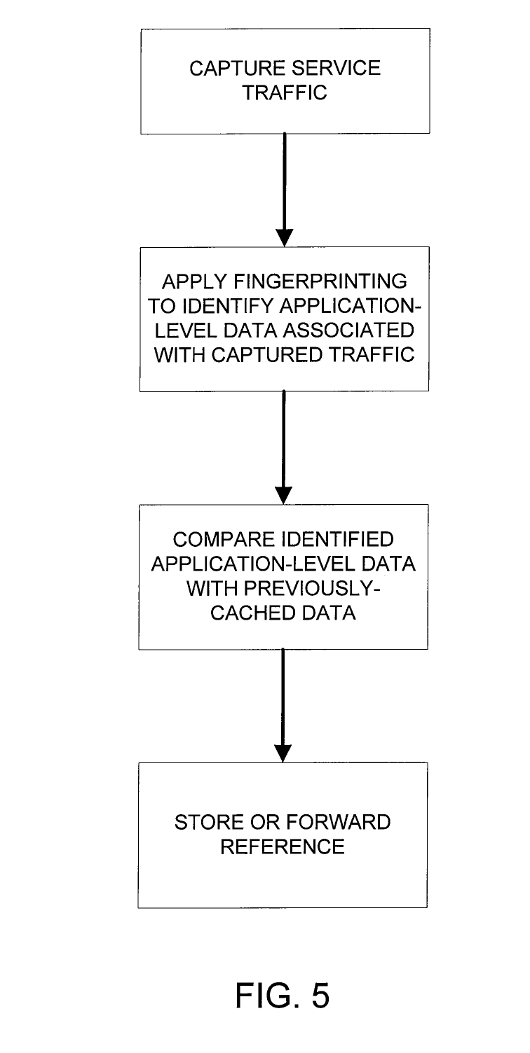

FIG. 5 illustrates a method of determining an efficient representation of service data for storage, compression, and communication according to an embodiment of the invention. In this method, service traffic and shared state data is fingerprinted using application-specific fingerprints. Application-specific fingerprints determine the context of data. Using these application fingerprints, the representation, storage, and communication of service traffic and shared state data can be optimized.

For example, application fingerprints for an e-mail service application can be used to identify service traffic including e-mail header information. Further application fingerprints may identify the location of specific header fields within the service. Using these application fingerprints, a service appliance may optimize data transfer and storage associated with email messages by separating header and body information. If a series of e-mail messages all include the same date in the header, then the service appliance only needs to represent this date one time. The other headers can include a reference to the date value instead. Similarly, e-mail attachments can be sent as files. Files only need to be represented once, with additional uses of the file represented as references and incremental changes, if necessary. All sequential changes in email messages can be sent as blocks to take advantage of the incremental block transfers.

The method of FIG. 5 starts by capturing service traffic. One or more application fingerprints are applied to service traffic to identify the service application associated with the service traffic, one or more data objects included in the service traffic, and/or the context of the data object (e.g., whether the data object is part of an e-mail header, body, or attachment). The identified data is referred to as application-level data, because it has been associated with a particular context of the application.

The identified application level-data is compared with a cache of previously processed application level-data. This comparison may be facilitated using hashes, indexes, or any other technique for identifying and accessing data. The hash computation can have an arbitrary level of granularity, based on knowledge of the format of the attachment—for example, a slide presentation file can be hashed slide by slide, with only changes to objects on a given slide re-cached and re-transmitted. Additional embodiments can hash and cache object meta-data and small portions (not attachments or BLOBs) of the object, e.g., a message body or 1K SQL character field.

In embodiments where this method is used to optimize network bandwidth, this cache may mirror a cache maintained locally by a process on a production server or another service appliance. If the application-level data corresponds with data already cached, then a reference to the cached data is constructed. This reference can include an indicator to the appropriate data in the cache. In further embodiments, this reference may also include a difference, if any, between the identified application-level data and the corresponding previously-cached data. The reference is then stored or forwarded to its destination. In a further embodiment, compressible attachment files and the message headers (in the changed data stream) will be compressed before sending across the network, for example using any type of lossy or lossless data compression.

For example, a first service traffic message can include a copy of an e-mail message and its attachment. Using application fingerprints, these portions of the service traffic are identified and cached separately. Thus, the cache may include a copy of the attached file, a copy of the header, and a copy of e-mail message body. A subsequent service traffic message may include a different e-mail message and a modified version of the attached file. Using the application fingerprints on the subsequent service traffic message, an embodiment of the invention can identify the attachment and recognize that it is a modified version of the previously-cached file. A difference between the original and modified versions of the file can be constructed. This difference can be stored with a reference to the cached version of the file or communicated to production server or other service appliance to reconstruct the modified version of the file.

An embodiment of this method may be implemented as an independent application or as a library. It can be linked to the existing application that needs to transfer data to peer applications through WAN links. This embodiment can easily be ported to wide range of embedded devices like cell phones, PDA and application servers and may be operating system independent.

This embodiment works at the session layer of the standard OSI model and is fully responsible for the integrity and in-order delivery of the data from the source to the target application. An embodiment works as Peer-to-Peer protocol that runs on devices present on both ends of the WAN links. An embodiment may act as a store-and-forward data transfer utility. Applications can pass the data to an embodiment as files or information blocks with start and end markers. The transmit side optimizes data for transmission to the receive end. The receive side retrieves the actual application data from the transferred data and passes it to the target application.

Embodiments can accept application data requests through multiple interface types. While running as an independent application it can accept data transfer requests through pipes, sockets or simply putting transfer data as files in specified directories. While running as a library, application can use direct function calls or message queues to a module.

An embodiment runs above the transport layer and establishes all transport layer connections needed per application session. This embodiment may be independent of the transport protocol; it can be configured to work with TCP as well as UDP transport layers. While working over TCP, it may advantage of TCP enhancements for high latency links.

A further embodiment can feature data compression that may be fully controlled by the application. The compression may be applied on a single transfer request level granularity.

An embodiment provides at least two modes of caching based on how application perceives the data changing pattern which is being sent to the other side. File based caching can optimize and prevent repeated transmission of data files independent of the file size. In case of a cache hit, a single transaction (request/response) between the peers is sufficient to complete the transfer of the file. This method significantly saves the bandwidth for large size file transfers. Block based caching is very useful for files that have incremental changes which are sequential in nature or localized to specific portions of the file. An embodiment can divide the requested file in smaller configurable blocks. It then performs the cache lookups and only transfer the blocks that are missing in the cache. As discussed above, application fingerprinting can be used to determine blocks of a file based upon the file type and context.

A further embodiment of block based caching can use application specific intelligence, both from the shared state data, and independently, to determine block-level changes at any level of depth inside data provided. For example, shared state data for e-mail service data might contain messages, which in turn contain both header data and attachments that need to be treated separately, with the attachments needing block level caching for each object in the attachment (e.g., a slide presentation file with multiple slides and graphic objects on each slide.)

In yet a further embodiment, the File and Block cache stays persistent on both peers. The caches are built on both peers without strict requirement of being in sync with each other. This is a significant difference from history-based compression where history buffers have to be in a complete synchronization state to perform successful data compression operations. If the cache is destroyed on the sender or receiver, it is rebuilt independently on the respective node.

Example Application Data Transfer Sequence

A typical data transfer sequence might comprise the following steps:

1. The application provides transmit data with three parameters, Data Type (file/buffer), Compression Flag (enable/disable), Transfer Mode (block/file), Block Size (16 KB-256 KB)

2. If the compression is enabled, compression is applied.

3. If the Transfer Mode is a “File” mode, an MD5 hash is computed for the input file. It sends the query to the receiver with the file name and MD5 hash. On receiving a “cache-hit” response from the receiver, the sender completes the data transfer phase. If the receiver responds with “cache-miss” then the file is transferred to it. The sender also checks local file cache for the same file entry. If the file exists, it refreshes the file access with latest timestamp and completes the transfer request. If the file does not exist in local cache, it creates new entry in the local cache.

4. If the Transfer Mode is “Block” mode, the data buffer or file is divided into blocks of specified block size. The MD5 hash is generated for each block. MD5 hashes are computed for individual blocks and queries are sent to the receiver for the batch of blocks. The receiver returns with the list of missing blocks and sender sends the missing blocks to the receiver. The sender also updates the local block cache with new information.

With application fingerprinting, the data is decomposed recursively into each appropriate level, and what is discovered at each level may be treated differently. For example, message data found by decomposing an Exchange object might be treated as a block transfer, while a non-compressible but non-volatile file attachment in the message might be treated via file mode.

5. Each file or block transfer session is assigned a unique session identifier. The block transfers are also accompanied by START_SESSION and END_SESSION markers. All file and block transfers have sequence numbers. The session identifiers and sequence numbers are used as a reference in NACK messages

6. The Receiver side makes sure it has successful data transfer session. It performs data checksum compares on received blocks and files. It only reports NACKs for error conditions or when sender has specific queries about the presence of files and data blocks in the receiver cache.

7. On receiving a transfer query for a file or batch of blocks, the receiver performs local cache lookups. If it finds the data in local cache it sends “cache hit” response and forwards the data to the receiver application. If local cache lookup fails, it responds with “cache miss”. Once receiver has seen complete data transfer, it updates receive cache with new data. It attempts to decompress the data if it is compressed. It passes the data to application through the selected interface.

Further embodiments can be envisioned to one of ordinary skill in the art after reading the attached documents. For example, although the above description of the invention focused on an example implementation of an electronic mail, calendaring, and collaboration service application, the invention is applicable for the implementation of any type of service application. In particular, electronic mail, calendaring, and collaboration service applications often include a database for storage and retrieval of such service applications' data. As such, an electronic mail, calendaring, and collaboration service application can be seen as a specific type of database application. Database applications are applications built around the use of a database, including merely providing database functionality in absence of other application features. One of ordinary skill in the art can easily appreciate that the invention can be used to implement any type of database application, with the example of an electronic mail, calendaring, and collaboration service application being merely a specific case of a more general principal. Moreover, the term database is used here in the sense of any electronic repository of data which provides some mechanism for the entry and retrieval of data, including but not limited to relational databases, object databases, file systems, and other data storage mechanisms.

In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A method of representing data of an entity, the method comprising:
intercepting service traffic associated with a first entity;
identifying a data object representing at least a portion of the state of the first entity in the service traffic; and
updating a corresponding portion of a shared state data structure in accordance with a value of the data object.

2. The method of claim 1, further comprising:
intercepting second service traffic associated with a second entity;
identifying a second data object representing at least a portion of the state of the second entity in the second service traffic; and
updating a corresponding portion of a shared state data structure in accordance with a value of the second data object.

3. The method of claim 1, wherein the service traffic is associated with an e-mail service application.

4. The method of claim 1, wherein the service traffic is associated with a database service application.

5. The method of claim 1, further comprising providing a synchronization command to initiate at least a portion of the service traffic.

6. The method of claim 1, further comprising forwarding the shared state information to a target production server.

7. The method of claim 1, further comprising:
applying at least one application fingerprint to the service traffic to identify a context of the first data object; and
caching the first data object based upon the context.

8. The method of claim 1, wherein the shared state information is adapted for use in disaster recovery.

9. The method of claim 1, wherein the shared state information is adapted for use in fault tolerance.

10. The method of claim 1, wherein the shared state information is adapted for use in service migration.
